(19) United States
(12) Patent Application Publication
(10) Pub. No.: US 2025/0308048 A1
(43) Pub. Date: Oct. 2, 2025

(54) LEARNING APPARATUS, ESTIMATION APPARATUS, LEARNING METHOD, ESTIMATION METHOD, AND STORAGE MEDIUM

(71) Applicant: HONDA MOTOR CO., LTD., Tokyo (JP)

(72) Inventors: Tanay DWIVEDI, Wako-shi (JP); Ryoji WAKAYAMA, Wako-shi (JP); Koki AIZAWA, Wako-shi (JP)

(21) Appl. No.: 19/042,527

(22) Filed: Jan. 31, 2025

(30) Foreign Application Priority Data
Mar. 28, 2024 (JP) 2024-054469

(51) Int. Cl. G06T 7/55

(52) U.S. Cl. CPC G06T 7/55; G06T 2207/20081; G06T 2207/20084

(57) ABSTRACT

A learning apparatus generates output data representing a disparity between first and second images in input data by inputting the input data to a model, and updates a parameter of the model to reduce a loss obtained by inputting the output data and ground truth data to a loss function. The model includes a feature generation unit configured to generate first and second features based on the first and second images, respectively, and a map generation unit configured to generate a disparity map of the disparity between the first and second images based on the first and second features. The map generation unit includes a cross-attention layer configured to receive inputs based on the first and second features. The disparity map is based on an output from the cross-attention layer.

### CROSS-REFERENCE TO RELATED APPLICATION(S)

This application claims priority to and the benefit of Japanese Patent Application No. 2024-054469, filed Mar. 28, 2024, the entire disclosure of which is incorporated herein by reference.

### BACKGROUND OF THE INVENTION

### Field of the Invention

The present invention relates to a learning apparatus, an estimation apparatus, a learning method, an estimation method, and a storage medium.

### Description of the Related Art

A disparity between two images obtained by imaging a subject from two different positions is estimated in order to estimate a distance to the subject. Japanese Patent Laid-Open No. 2020-526818 and Japanese Patent Laid-Open No. 2021-519983 describe methods for estimating a disparity between two images by machine learning. Vladimir Tankovich, “HITNet: Hierarchical Iterative Tile Refinement Network for Real-time Stereo Matching”, Jan. 19, 2023, arXiv, describes a model called hierarchical iterative tile refinement network (HITNet), which generates a disparity map of two images and then fine-tunes the disparity map. The use of machine learning has improved accuracy in estimating a disparity between two images. However, there is room for improvement in disparity estimation accuracy.

### SUMMARY OF THE INVENTION

One aspect of the present invention provides a technology for accurately estimating a disparity between two images.

According to some embodiments, a learning apparatus for performing machine learning is provided. The learning apparatus is configured to: acquire teaching data including input data and ground truth data, the input data including a first image and a second image; generate output data representing a disparity between the first image and the second image by inputting the input data to a model; and update a parameter of the model to reduce a loss obtained by inputting the output data and the ground truth data to a loss function. The model includes: a feature generation unit configured to generate a first feature based on the first image and generate a second feature based on the second image; and a map generation unit configured to generate a disparity map of the disparity between the first image and the second image based on the first feature and the second feature. The map generation unit includes a cross-attention layer configured to receive an input based on the first feature and an input based on the second feature. The disparity map is based on an output from the cross-attention layer.

### BRIEF DESCRIPTION OF THE DRAWINGS

FIG. 1 is a block diagram for describing a hardware configuration example of a computer according to some embodiments;

FIG. 2 is a schematic diagram for describing an example of input data according to some embodiment;

FIG. 3 is a schematic diagram for describing a configuration example of a model according to some embodiments;

FIG. 4 is a schematic diagram illustrating a configuration example of a feature generation unit according to some embodiments;

FIG. 5 is a schematic diagram for describing a configuration example of a self-attention layer according to some embodiments;

FIG. 6 is a schematic diagram for describing a configuration example of a cross-attention layer according to some embodiments;

FIG. 7 is a schematic diagram for describing a configuration example of a model according to some embodiments;

FIG. 8 is a flowchart for describing an example of a learning method according to some embodiments; and

FIG. 9 is a flowchart for describing an example of an estimation method according to some embodiments.

### DESCRIPTION OF THE EMBODIMENTS

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

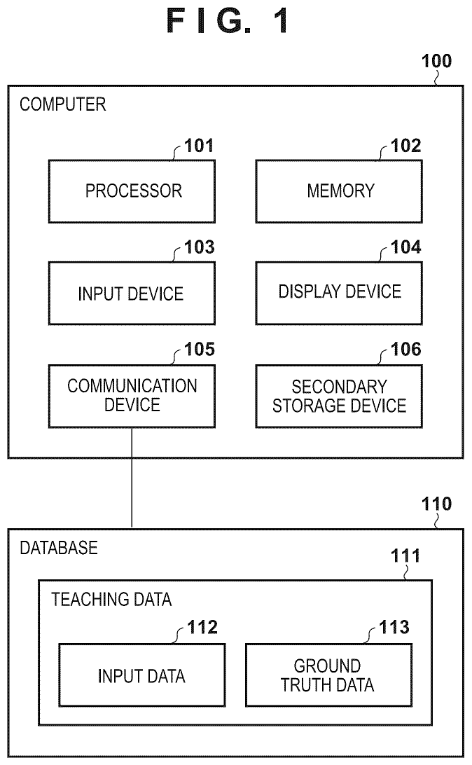

A hardware configuration example of a computer 100 according to some embodiments will be described with reference to FIG. 1. As described in detail below, the computer 100 is used to train a model by machine learning. Thus, the computer 100 may be referred to as a learning apparatus. The computer 100 may be, for example, a server computer or a personal computer (for example, a desktop type or a laptop type). The computer 100 may be a computer resource disposed on a cloud environment.

The computer 100 may include a hardware device illustrated in FIG. 1. A processor 101 controls an overall operation of the computer 100. The processor 101 may be implemented by, for example, a central processing unit (CPU), a graphics processing unit (GPU), or a combination thereof. The processor 101 may be a single processor, or may be a set of a plurality of processors communicatively connected to each other.

A memory 102 stores programs and data used for processing in the computer 100. The memory 102 may be implemented by, for example, a combination of a random access memory (RAM) and a read only memory (ROM).

An input device 103 is a device for acquiring an instruction from a user of the computer 100. The input device 103 may be implemented by, for example, a combination of one or more of a keyboard, a button, a touch pad, and a microphone. A display device 104 is a device for visually presenting information to the user of the computer 100. The display device 104 may be, for example, a dot matrix display such as a liquid crystal display. The computer 100 may include a device (for example, a touch screen) in which the input device 103 and the display device 104 are integrated with each other. The input device 103 and the display device 104 may be provided outside the computer. In this case, the computer 100 may include an interface for communicating with the external input device 103 and the external display device 104.

A communication device 105 is a device for communicating with a device outside the computer 100. In a case where the computer 100 performs wired communication, the communication device 105 may be a network interface card (NIC) including a connector for connecting a cable. In a case where the computer 100 performs wireless communication, the communication device 105 may be a wireless communication module including an antenna and a baseband processing circuit.

A secondary storage device 106 is a device for storing programs and data used for processing in the computer 100 in a nonvolatile manner. The secondary storage device 106 is implemented by, for example, a hard disk drive (HDD) or a solid-state drive (SSD).

The computer 100 may be capable of communicating with an external database 110. The database 110 may store teaching data 111 used for machine learning by the computer 100. The computer 100 may acquire the teaching data 111 from the database 110. Alternatively or additionally, the teaching data 111 may be stored in the secondary storage device 106 of the computer 100. In machine learning, a plurality of pieces of different teaching data 111 are used. Two pieces of teaching data 111 being different may mean that pieces of input data 112 included in the two pieces of teaching data 111 are different from each other. Some of the pieces of teaching data 111 may be used as verification data and test data.

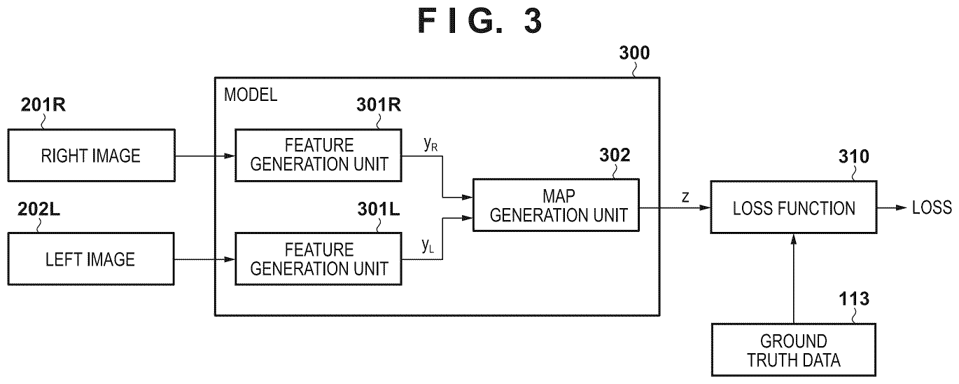

The teaching data 111 includes the input data 112 and ground truth data 113. The input data 112 may be data input to a model in order to train the model (for example, a model 300 of FIG. 3). The ground truth data 113 may be data to be output by the model.

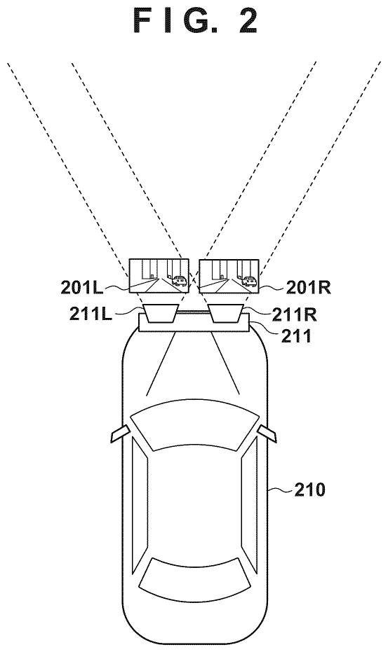

An example of the input data 112 will be described with reference to FIG. 2. The input data 112 may include a pair of two images. Hereinafter, the pair of two images is referred to as an image pair. The image pair included in the input data 112 may be two images captured by a stereo camera 211. For example, the stereo camera 211 may include a right camera 211R and a left camera 211L that are arranged so as to be spatially spaced apart from each other. The image pair included in the input data 112 may be a right image 201R captured by the right camera 211R and a left image 201L captured by the left camera 211L. Typically, the right image 201R and the left image 201L have the same resolution. The right image 201R and the left image 201L may be color images or monochrome images.

The stereo camera 211 may be attached to a vehicle 210. The vehicle 210 may be a vehicle or micro mobility vehicle that can be boarded by an occupant. Alternatively, the stereo camera 211 may be attached to a mobile body other than the vehicle 210. For example, the stereo camera 211 may be attached to a robot or the like that carries baggage or leads a person. For example, the stereo camera 211 may be attached to the vehicle 210 so as to image an area in front of the vehicle 210. Alternatively, the image pair included in the input data 112 may be images captured by a camera (for example, a smartphone of the occupant of the vehicle) brought into the vehicle 210. The image pair included in the input data 112 may be images that are not related to the vehicle. Further, the image pair included in the input data 112 may be two images of the same subject imaged by one camera at different time points.

The ground truth data 113 may include a disparity map of the image pair included in the input data 112. The disparity map may be an image representing a disparity in each pixel between the right image 201R and the left image 201L. The disparity map may be generated based on one of the right image 201R and the left image 201L. In the following description, a case where the disparity map is represented with reference to the right image 201R will be described. Alternatively, the disparity map may be represented with reference to the left image 201L.

A pixel value of a specific pixel of the disparity map represents a distance between a pixel at the same position as the specific pixel in the right image 201R and a pixel in the left image 201L that represents the same subject as the pixel in the right image 201R. The disparity map may have the same resolution (that is, the same number of pixels) as the right image 201R. In this case, one pixel of the disparity map corresponds to one pixel of the right image 201R. A disparity of one pixel of the right image 201R is represented by a pixel value of the corresponding one pixel of the disparity map. Alternatively, the disparity map may have a lower resolution (that is, a smaller number of pixels) than the right image 201R. In this case, one pixel of the disparity map corresponds to a plurality of pixels of the right image 201R. A disparity of each of the plurality of pixels of the right image 201R is represented by a pixel value of one corresponding pixel of the disparity map.

The model 300 on which machine learning is performed by the computer 100 will be described with reference to FIG. 3. The model 300 generates output data based on the input data 112. As described above, the input data 112 can include the right image 201R and the left image 201L. The output data can include the disparity map. The disparity map represents the disparity between the right image 201R and the left image 201L. The output data output from the model 300 is input to a loss function 310 at the time of training of the model 300. The ground truth data 113 corresponding to the input data 112 is also input to the loss function 310. The output data of the model 300 may have the same data structure as the ground truth data 113. The loss function 310 outputs a loss based on an error between the output data and the ground truth data 113.

The model 300 includes two feature generation units 301R and 301L and a map generation unit 302. The model 300 may include other components. The feature generation unit 301R generates a feature representing the right image 201R based on the right image 201R. In the following description, the feature representing the right image 201R is represented as a right feature y_{R}. The right image 201R may be represented by, for example, a three-dimensional array of (height)×(width)×(the number of channels). The right feature y_{R} may be represented by, for example, a three-dimensional array of (height)×(width)×(the number of channels). A resolution of the right feature y_{R} may be the same as or lower than the resolution of the right image 201R.

The feature generation unit 301L generates a feature representing the left image 201L based on the left image 201L. In the following description, the feature representing the left image 201L is represented as a left feature y_{L}. A data structure of the left image 201L may be the same as a data structure of the right image 201R. A data structure of the left feature y_{L} may be the same as a data structure of the right feature y_{R}.

The map generation unit 302 generates a disparity map z between the right image 201R and the left image 201L based on the right feature y_{R} and the left feature y_{L}. The disparity map z may be represented by, for example, a two-dimensional array of (height)×(width). A resolution of the disparity map z may be the same as or lower than the resolution of the right image 201R.

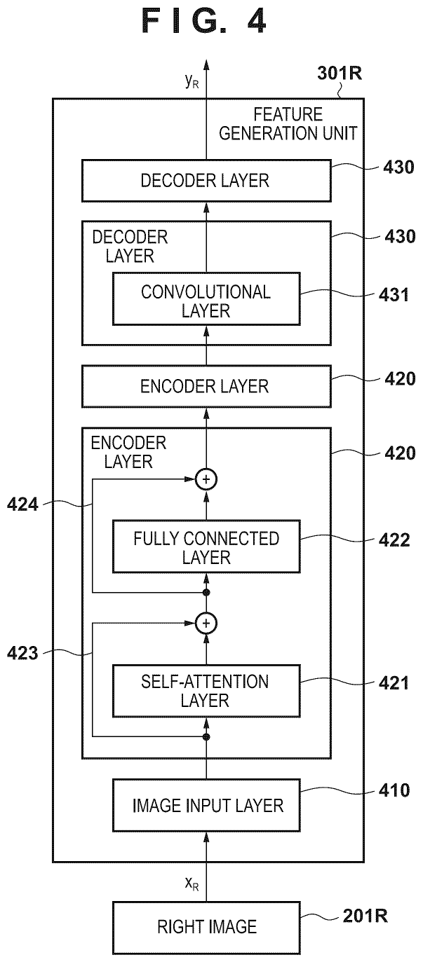

Next, a configuration example of the feature generation unit 301R will be described with reference to FIG. 4. The feature generation unit 301L may have the same configuration as the feature generation unit 301R. The feature generation unit 301R includes an image input layer 410, a plurality of encoder layers 420, and a plurality of decoder layers 430. The feature generation unit 301R may include other layers. In the example of FIG. 4, the feature generation unit 301R includes two consecutive encoder layers 420. Alternatively, the feature generation unit 301R may include another number of encoder layers 420, for example, may include only one encoder layer 420. In the example of FIG. 4, the feature generation unit 301R includes two consecutive decoder layers 430. Alternatively, the feature generation unit 301R may include another number of decoder layers 430, for example, may include only one decoder layer 430. In the example of FIG. 4, the plurality of encoder layers 420 are connected in series after the image input layer 410, and then the plurality of decoder layers 430 are connected in series. Alternatively, the plurality of encoder layers 420 and the plurality of decoder layers 430 may be arranged so as to be interwoven.

The image input layer 410 converts the right image 201R into a format to be input to the encoder layer 420. The image input layer 410 may have a configuration similar to that of an input layer of a vision transformer (ViT). For example, the image input layer 410 converts the right image 201R into a plurality of vectors. For example, the image input layer 410 may divide the right image 201R into a plurality of patch images and may rearrange pixel values of the patch images into one-dimensional vectors. Further, the image input layer 410 may embed a position of the patch image in the one-dimensional vector similarly to the input layer of the VIT. The image input layer 410 outputs a plurality of one-dimensional vectors representing the right image 201R. The image input layer 410 may further output a cluster token having the same size as the patch image.

The encoder layer 420 encodes each of the plurality of vectors input from an upstream layer. As a result, a feature is extracted from data input to the encoder layer 420. The encoder layer 420 may generate output data having a resolution lower than that of the input data. In this case, the resolution of the data decreases by passing through one encoder layer 420.

The encoder layer 420 may have a configuration similar to that of an encoder block of the VIT. For example, the encoder layer 420 may include a self-attention layer 421 and a fully connected layer 422. The plurality of vectors input to the encoder layer 420 are converted into a plurality of different vectors by the self-attention layer 421. The plurality of vectors output from the self-attention layer 421 are converted into a plurality of different vectors by the fully connected layer 422. The plurality of vectors output from the fully connected layer 422 are output from the encoder layer 420. An input to each layer (for example, the self-attention layer 421) of the feature generation unit 301R is based on the right image 201R. An output (that is, the right feature y_{R}) from the feature generation unit 301R is based on an output of each layer (for example, the self-attention layer 421) of the feature generation unit 301R.

The encoder layer 420 may include a path 423 that bypasses the self-attention layer 421. In this case, an input to the self-attention layer 421 is added to an output from the self-attention layer 421. Alternatively, the encoder layer 420 does not have to include the path 423. The encoder layer 420 may include a path 424 that bypasses the fully connected layer 422. In this case, an input to the fully connected layer 422 is added to an output from the fully connected layer 422. Alternatively, the encoder layer 420 does not have to include the path 424. The encoder layer 420 may further include a normalization layer provided upstream of the self-attention layer 421. The encoder layer 420 may further include a normalization layer provided upstream of the fully connected layer 422.

The decoder layer 430 decodes each of the plurality of vectors input from an upstream layer. As a result, a feature is extracted from data input to the decoder layer 430. The decoder layer 430 may generate output data having a resolution higher than that of the input data. In this case, the resolution of the data increases by passing through one decoder layer 430.

The decoder layer 430 may have a configuration similar to that of a decoder block of the HITNet. For example, the decoder layer 430 may include a convolutional layer 431. The plurality of vectors input to the decoder layer 430 are converted into a plurality of different vectors by the convolutional layer 431. In FIG. 4, the decoder layer 430 includes one convolutional layer 431. Alternatively, the decoder layer 430 may include a plurality of convolutional layers having different parameters (for example, filter sizes and strides).

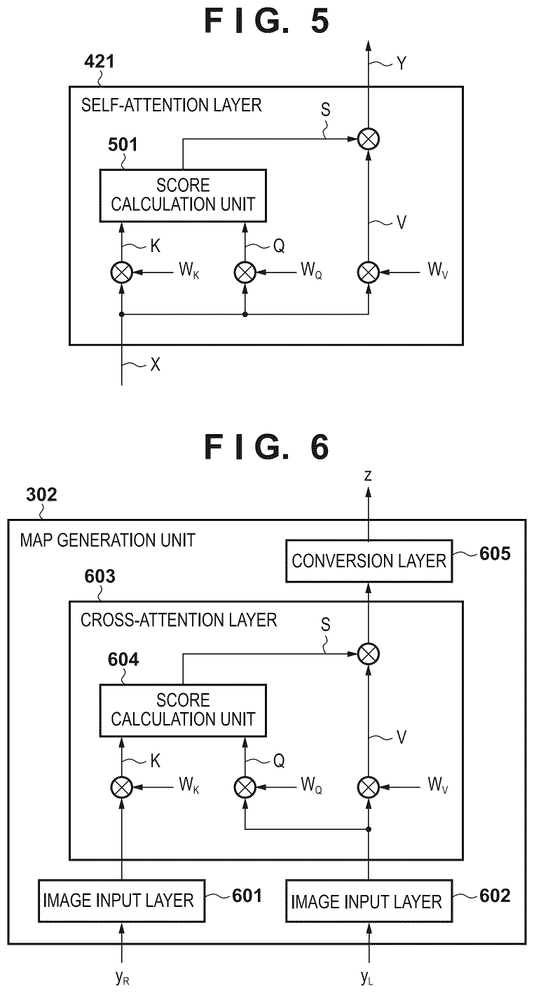

A configuration example of the self-attention layer 421 will be described with reference to FIG. 5. Each of a plurality of output vectors of the self-attention layer 421 represents a relationship of another input vector with respect to each input vector in the plurality of input vectors of the self-attention layer 421. The self-attention layer 421 combines a plurality of input row vectors into one two-dimensional input matrix X. The self-attention layer 421 calculates a query Q, a key K, and a value V by multiplying the input matrix X by a weight matrix W_{Q}, a weight matrix W_{K}, and a weight matrix W_{V} from the right. The weight matrix W_{Q}, the weight matrix W_{K}, and the weight matrix W_{V} are parameters determined by machine learning.

The self-attention layer 421 includes a score calculation unit 501. The score calculation unit 501 calculates a score S based on the query Q and the key K. Specifically, the score calculation unit 501 calculates an intermediate matrix by multiplying the query Q by a transposed matrix of the key K from the right and dividing each component by a predetermined value (for example, a square root of the number of columns of the key K). Thereafter, the score calculation unit 501 calculates the score S by applying a Softmax function to each row of the intermediate matrix. Thereafter, the self-attention layer 421 calculates a matrix Y by multiplying the score S by the value V from the right. The self-attention layer 421 outputs the matrix Y calculated in this manner. A plurality of rows of the matrix Y correspond to a plurality of row vectors output from the self-attention layer 421.

As described above, the feature generation unit 301R includes the self-attention layer 421, and thus, the feature generation unit 301R can accurately extract the feature over the entire right image 201R. The same applies to the feature generation unit 301L.

Next, a configuration example of the map generation unit 302 will be described with reference to FIG. 6. The map generation unit 302 includes image input layers 601 and 602, a cross-attention layer 603, and a conversion layer 605. The map generation unit 302 may include other layers.

The image input layer 601 converts the right feature y_{R} into a plurality of vectors similarly to the image input layer 410. The image input layer 602 converts the left feature y_{L} into a plurality of vectors similarly to the image input layer 410. The cross-attention layer 603 combines a plurality of row vectors output from the image input layer 601 into one two-dimensional input matrix and calculates a key K by multiplying the input matrix by a weight matrix W_{K} from the right. The cross-attention layer 603 combines a plurality of row vectors output from the image input layer 602 into one two-dimensional input matrix, calculates a query Q by multiplying the input matrix by a weight matrix W_{Q} from the right, and calculates a value V by multiplying the input matrix by a weight matrix W_{V} from the right. The weight matrix W_{Q}, the weight matrix W_{K}, and the weight matrix W_{V} are parameters determined by machine learning. The parameters of the cross-attention layer 603 may have different values than the self-attention layer 421. In the example of FIG. 6, the right feature y_{R} is input to the image input layer 601, and the left feature y_{L} is input to the image input layer 602. Alternatively, the left feature y_{L} may be input to the image input layer 601, and the right feature y_{R} may be input to the image input layer 602.

The score calculation unit 604 calculates a score S based on the query Q and the key K in the same manner as the score calculation unit 501. Thereafter, the cross-attention layer 603 outputs a matrix obtained by multiplying the score S by the value V from the right. The conversion layer 605 converts the output from the cross-attention layer 603 into the data structure of the disparity map z.

The cross-attention layer 603 receives an input based on the right feature y_{R} and an input based on the left feature y_{L}. The disparity map z is based on the output from the cross-attention layer 603. As a result, the map generation unit 302 can accurately associate a pixel of the right image 201R with a pixel of the left image 201L. Specifically, the score calculation unit 604 of the cross-attention layer 603 calculates a score between the input based on the right feature y_{R} and the input based on the left feature y_{L} for each of a plurality of disparities, and the plurality of disparities are weighted based on the score to perform disparity estimation. Therefore, the disparity is estimated with finer granularity than when any one of the plurality of disparities is selected.

In the above-described example, an output from the map generation unit 302 is used as an output (that is, the disparity map z) from the model 300. Alternatively, the model 300 may include a layer for fine-tuning the output of the map generation unit 302, the layer being provided downstream of the map generation unit 302. The layer for fine tuning may be, for example, an existing configuration, or may be a configuration used in the HITNet, for example.

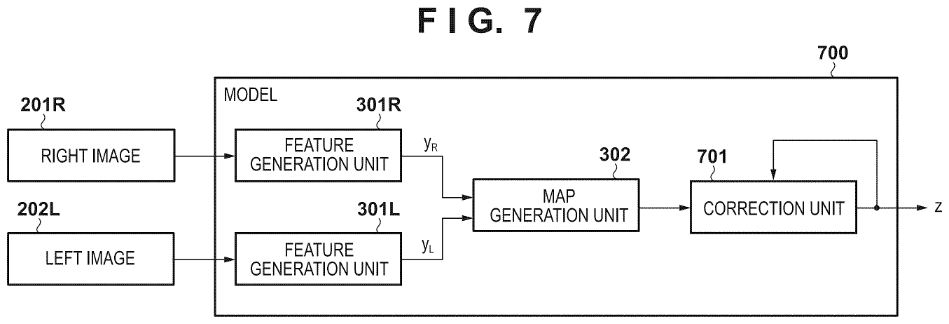

A modified example of the model 300 will be described with reference to FIG. 7. The model 700 is different from the model 300 in further including a correction unit 701 provided downstream of the map generation unit 302. In a case where the model 700 is used, the input data 112 may include time-series data of image pairs. The image pairs may be input to the model 700 in chronological order (that is, from an old image pair to a new image pair).

The map generation unit 302 generates a disparity map based on the image pair (that is, the right image 201R and the left image 201L) at each time point, and outputs the disparity map to the correction unit 701. The correction unit 701 corrects the disparity map generated by the map generation unit 302. Specifically, the correction unit 701 corrects, based on a disparity map generated by the map generation unit 302 for an image pair at a certain time point, a disparity map generated by the map generation unit 302 for an image pair at a time point later than the certain time point. In other words, the correction unit 701 corrects a disparity map generated by the map generation unit 302 for the current image pair based on a disparity map generated by the map generation unit 302 for the past image pair.

The correction unit 701 may include, for example, a gated recurrent unit (GRU) or a convolutional gated recurrent unit (ConvGRU). Specifically, the correction unit 701 may store internal data representing the disparity map generated by the map generation unit 302 for the past image pair, and correct the disparity map generated by the map generation unit 302 for the current image pair based on the internal data.

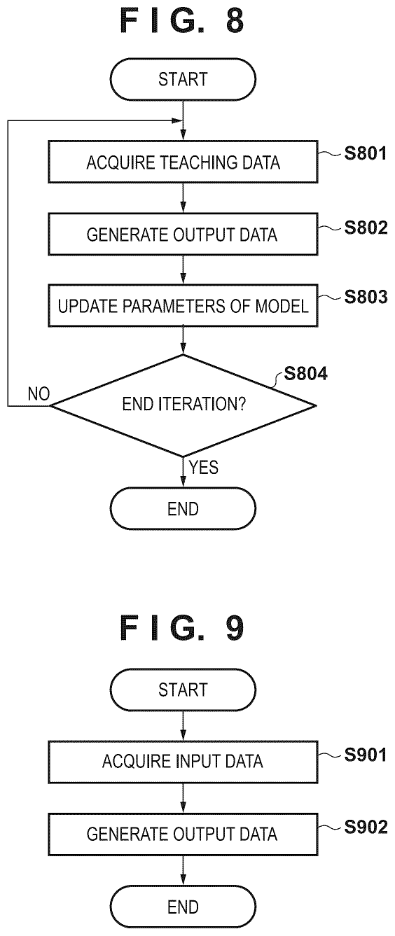

An example of a learning method for training the model 300 will be described with reference to FIG. 8. Each step of the method of FIG. 8 may be performed, for example, by the processor 101 of the computer 100 executing a program read into the memory 102. Alternatively, some or all of the steps of the method of FIG. 8 may be performed by a dedicated circuit such as an application-specific integrated circuit (ASIC). At a start point in time of FIG. 8, the parameters of the model 300 may be randomly set values.

In S801, the computer 100 acquires one piece of teaching data 111. The teaching data 111 may be read from the database 110 at this point in time, or may be stored in the secondary storage device 106 in advance. Instead of using the pieces of teaching data 111 one by one, the plurality of pieces of teaching data 111 may be collectively used as a batch.

In S802, the computer 100 generates the output data by inputting the input data 112 included in the teaching data 111 acquired in S801 to the model 300. As described above, the output data may include the disparity map.

In S803, the computer 100 updates the parameters of the model 300 to reduce the loss obtained by inputting the output data generated in S802 and the ground truth data 113 included in the teaching data 111 acquired in S801 to the loss function 310. The parameters may be updated by using an existing method such as Adam. The loss function 310 may include, for example, an LI error of the pixel value.

In S804, the computer 100 determines whether or not a condition (hereinafter, referred to as end condition) for ending iteration of the parameter update is satisfied. In a case where it is determined that the end condition is satisfied (“YES” in S804), the computer ends the processing, and otherwise (“NO” in S804), the processing proceeds to S801. The end condition may be that the parameter is updated a predetermined number of times (that is, S804 is executed). After the processing of FIG. 8 is executed, the computer 100 may store the trained model 300 in the secondary storage device 106 for future processing, or may transmit the model to another device (for example, the database 110).

Next, an example of an estimation method for estimating the disparity by using the model 300 will be described with reference to FIG. 9. The estimation method of FIG. 9 may be executed by the computer 100, for example. Therefore, the computer 100 may be referred to as an estimation apparatus. The computer 100 executing the estimation method of FIG. 9 may be different from the computer 100 executing the learning method of FIG. 8. Each step of the method of FIG. 9 may be performed, for example, by the processor 101 of the computer 100 executing a program read into the memory 102. Alternatively, some or all of the steps in the method of FIG. 9 may be performed by a dedicated circuit such as an ASIC. At a start point in time of FIG. 9, it is assumed that the trained model 300 is available to the computer 100. For example, the trained model 300 may be stored in the secondary storage device 106 of the computer 100.

In S901, the computer 100 acquires the input data to be input to the model 300. The input data may include the right image 201R and the left image 201L. The input data may be an image captured by the stereo camera 211 of the mobile body such as the vehicle 210.

In S902, the computer 100 generates the output data by inputting the input image acquired in S901 to the model 300. As described above, the output data of the model 300 includes the disparity map. The disparity map indicates an estimated value of the disparity between the right image 201R and the left image 201L. Therefore, in S902, the disparity between the right image 201R and the left image 201L is estimated. The computer 100 may create a depth map based on the estimated disparity, and use the depth map for controlling the mobile body such as the vehicle 210.

### Summary of Embodiments

### [Item 1]

A learning apparatus (100) for performing machine learning, the learning apparatus configured to:
acquire teaching data including input data (112) and ground truth data (113), the input data including a first image (201R) and a second image (201L);
generate output data representing a disparity between the first image and the second image by inputting the input data to a model (300, 700); and
update a parameter of the model to reduce a loss obtained by inputting the output data and the ground truth data to a loss function (310), wherein
the model includes:
   a feature generation unit (301) configured to generate a first feature based on the first image and generate a second feature based on the second image; and
   a map generation unit (302) configured to generate a disparity map of the disparity between the first image and the second image based on the first feature and the second feature,
the map generation unit includes a cross-attention layer (603) configured to receive an input based on the first feature and an input based on the second feature, and
the disparity map is based on an output from the cross-attention layer.

According to this item, it is possible to generate the model capable of accurately specifying a correspondence between two images, and it is thus possible to accurately estimate a disparity between the two images.

### [Item 2]

The learning apparatus according to Item 1, wherein
the feature generation unit includes a self-attention layer (421),
an input to the self-attention layer is based on the first image, and
the first feature is based on an output of the self-attention layer.

According to this item, it is possible to generate the model capable of appropriately extracting a feature of an image, and it is thus possible to more accurately estimate a disparity between two images.

### [Item 3]

The learning apparatus according to Item 2, wherein the feature generation unit includes a path (423) that bypasses the self-attention layer.

According to this item, it is possible to generate the model capable of more appropriately extracting a feature of an image, and it is thus possible to more accurately estimate a disparity between two images.

### [Item 4]

The learning apparatus according to any one of Items 1-3, wherein
the input data includes time-series data of image pairs of the first image and the second image,
the model further includes a correction unit (701) configured to correct the disparity map generated by the map generation unit, and
the correction unit corrects, based on the disparity map generated by the map generation unit for the image pair at a first time point, the disparity map generated by the map generation unit for the image pair at a second time point after the first time point.

According to this item, a disparity between two images can be estimated more accurately by using time-series data.

### [Item 5]

The learning apparatus according to Item 4, wherein the correction unit is configured by a convolutional gated recurrent unit (ConvGRU).

According to this item, a disparity between two images can be estimated more accurately.

### [Item 6]

The learning apparatus according to any one of Items 1-5, wherein the first image and the second image are two images captured by a stereo camera (211) of a mobile body (210).

According to this item, a disparity between two images used in the mobile body can be estimated more accurately.

### [Item 7]

A non-transitory computer-readable storage medium storing a program for causing a computer to function as the learning apparatus according to any one of Items 1-6.

According to this item, the above effect is obtainable in the form of a program.

### [Item 8]

An estimation apparatus (100) for performing disparity estimation, the estimation apparatus configured to:
acquire input data including a first image (201R) and a second image (201L); and
estimate a disparity between the first image and the second image by inputting the input data to a model (300, 700), wherein
the model includes:
   a feature generation unit (301) configured to generate a first feature based on the first image and generate a second feature based on the second image; and
   a map generation unit (302) configured to generate a disparity map of the disparity between the first image and the second image based on the first feature and the second feature,
the map generation unit includes a cross-attention layer (603) configured to receive an input based on the first feature and an input based on the second feature, and
the disparity map is based on an output from the cross-attention layer.

According to this item, a disparity between two images can be accurately estimated by using the model capable of accurately specifying a correspondence between the two images.

### [Item 9]

A non-transitory computer-readable storage medium storing a program for causing a computer to function as the estimation apparatus according to Item 8.

According to this item, the above effect is obtainable in the form of a program.

### [Item 10]

A method for performing machine learning, the method comprising:
acquiring (S801) teaching data including input data (112) and ground truth data (113), the input data including a first image (201R) and a second image (201L);
generating (S802) output data representing a disparity between the first image and the second image by inputting the input data to a model (300, 700); and
updating (S803) a parameter of the model to reduce a loss obtained by inputting the output data and the ground truth data to a loss function (310), wherein
the model includes:
   a feature generation unit (301) configured to generate a first feature based on the first image and generate a second feature based on the second image; and
   a map generation unit (302) configured to generate a disparity map of the disparity between the first image and the second image based on the first feature and the second feature,
the map generation unit includes a cross-attention layer (603) configured to receive an input based on the first feature and an input based on the second feature, and
the disparity map is based on an output from the cross-attention layer.

According to this item, it is possible to generate the model capable of accurately specifying a correspondence between two images, and it is thus possible to accurately estimate a disparity between the two images.

### [Item 11]

A method for disparity estimation, the method comprising:
acquiring (S901) input data including a first image (201R) and a second image (201L); and
estimating (S902) a disparity between the first image and the second image by inputting the input data to a model (300, 700), wherein
the model includes:
   a feature generation unit (301) configured to generate a first feature based on the first image and generate a second feature based on the second image; and
   a map generation unit (302) configured to generate a disparity map of the disparity between the first image and the second image based on the first feature and the second feature,
the map generation unit includes a cross-attention layer (603) configured to receive an input based on the first feature and an input based on the second feature, and
the disparity map is based on an output from the cross-attention layer.

According to this item, a disparity between two images can be accurately estimated by using the model capable of accurately specifying a correspondence between the two images.

The invention is not limited to the foregoing embodiments, and various variations/changes are possible within the spirit of the invention.

What is claimed is:

1. A learning apparatus for performing machine learning, the learning apparatus configured to:
acquire teaching data including input data and ground truth data, the input data including a first image and a second image;
generate output data representing a disparity between the first image and the second image by inputting the input data to a model; and
update a parameter of the model to reduce a loss obtained by inputting the output data and the ground truth data to a loss function, wherein
the model includes:
a feature generation unit configured to generate a first feature based on the first image and generate a second feature based on the second image; and
a map generation unit configured to generate a disparity map of the disparity between the first image and the second image based on the first feature and the second feature,
the map generation unit includes a cross-attention layer configured to receive an input based on the first feature and an input based on the second feature, and
the disparity map is based on an output from the cross-attention layer.

2. The learning apparatus according to claim 1, wherein
the feature generation unit includes a self-attention layer,
an input to the self-attention layer is based on the first image, and
the first feature is based on an output of the self-attention layer.

3. The learning apparatus according to claim 2, wherein the feature generation unit includes a path that bypasses the self-attention layer.

4. The learning apparatus according to claim 1, wherein
the input data includes time-series data of image pairs of the first image and the second image,
the model further includes a correction unit configured to correct the disparity map generated by the map generation unit, and
the correction unit corrects, based on the disparity map generated by the map generation unit for the image pair at a first time point, the disparity map generated by the map generation unit for the image pair at a second time point after the first time point.

5. The learning apparatus according to claim 4, wherein the correction unit is configured by a convolutional gated recurrent unit (ConvGRU).

6. The learning apparatus according to claim 1, wherein the first image and the second image are two images captured by a stereo camera of a mobile body.

7. A non-transitory computer-readable storage medium storing a program for causing a computer to function as the learning apparatus according to claim 1.

8. An estimation apparatus for performing disparity estimation, the estimation apparatus configured to:
acquire input data including a first image and a second image; and
estimate a disparity between the first image and the second image by inputting the input data to a model, wherein
the model includes:
a feature generation unit configured to generate a first feature based on the first image and generate a second feature based on the second image; and
a map generation unit configured to generate a disparity map of the disparity between the first image and the second image based on the first feature and the second feature,
the map generation unit includes a cross-attention layer configured to receive an input based on the first feature and an input based on the second feature, and
the disparity map is based on an output from the cross-attention layer.

9. A non-transitory computer-readable storage medium storing a program for causing a computer to function as the estimation apparatus according to claim 8.

10. A method for performing machine learning, the method comprising:
acquiring teaching data including input data and ground truth data, the input data including a first image and a second image;
generating output data representing a disparity between the first image and the second image by inputting the input data to a model; and
updating a parameter of the model to reduce a loss obtained by inputting the output data and the ground truth data to a loss function, wherein
the model includes:
a feature generation unit configured to generate a first feature based on the first image and generate a second feature based on the second image; and
a map generation unit configured to generate a disparity map of the disparity between the first image and the second image based on the first feature and the second feature,
the map generation unit includes a cross-attention layer configured to receive an input based on the first feature and an input based on the second feature, and
the disparity map is based on an output from the cross-attention layer.

11. A method for disparity estimation, the method comprising:
acquiring input data including a first image and a second image; and
estimating a disparity between the first image and the second image by inputting the input data to a model, wherein
the model includes:
a feature generation unit configured to generate a first feature based on the first image and generate a second feature based on the second image; and
a map generation unit configured to generate a disparity map of the disparity between the first image and the second image based on the first feature and the second feature,
the map generation unit includes a cross-attention layer configured to receive an input based on the first feature and an input based on the second feature, and
the disparity map is based on an output from the cross-attention layer.
